(19) United States
(12) Patent Application Publication
(10) Pub. No.: US 2015/0308794 A1
(43) Pub. Date: Oct. 29, 2015

(54) CONDUCTIVE COMPOSITE BALLISTIC IMPACT DETECTION SYSTEM

(71) Applicant: Pratt & Miller Engineering and Frabrication, Inc., New Hudson, MI (US)

(72) Inventors: Christopher A. Hammond, South Lyon, MI (US); Christopher Morgan, Ann Arbor Township, MI (US); Jonathan Nicols, Ann Arbor, MI (US)

(73) Assignee: Pratt & Miller Engineering and Fabrication, Inc., New Hudson, MI (US)

(21) Appl. No.: 14/330,858

(22) Filed: Jul. 14, 2014

Related U.S. Application Data
(60) Provisional application No. 61/845,755, filed on Jul. 12, 2013.

(51) Int. Cl. F41J 5/04; B32B 25/04; B32B 15/06; B32B 9/00

(52) U.S. Cl. CPC F41J 5/042; B32B 9/007; B32B 25/04; B32B 15/06; B32B 2605/00; B32B 2571/02; B32B 2307/202; B32B 2307/206

(57) ABSTRACT

Systems and methods are provided for detecting, communicating and storing hit events that impact objects. Conductive projectiles pierce a first layer of conductive material and insulative material to cause an electrical connection between the first layer and a second layer of conductive material. A signal is generated including at least the fact of a hit event, and the data may be stored and remotely accessible.

### CROSS-REFERENCE TO RELATED APPLICATIONS

This application claims the priority to U.S. Provisional Patent Application No. 61/845,755 filed Jul. 12, 2013, which is hereby incorporated by reference in its entirety.

### TECHNICAL FIELD

The disclosure herein relates generally to systems and methods for detecting when an object, such as a manned or unmanned vehicle, has been hit with one or more projectiles, including conductive projectiles such as ammunition.

### BACKGROUND

Objects such as unmanned vehicles, sometimes used in military applications, can be the subject of attack. For example, such vehicles may be targeted and shot with any of a number of weapons. Because the vehicles are unmanned, it may be difficult to assess whether and to what extent the unmanned vehicle has been hit.

Such knowledge may be useful for, by way of example, understanding the structural integrity of the object and whether it needs repair or is likely to be repairable. Some objects may need to be abandoned, others may be repaired. The quantity and quality of hit events may reveal information about enemy locations, weaponry or other strategic information. Thus, it may be desirable to detect hit events on an unmanned vehicle and, from a remote position, make strategic decisions based upon data available describing the hit event(s).

The disclosed apparatuses and methods may provide one or more such advantages.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 depicts an exemplary composite material applied to an unmanned object.

FIG. 2 depicts an exemplary composite material pierced by a bullet.

FIG. 3 depicts an exemplary method relating to detecting and communicating hit events on an unmanned object.

### DETAILED DESCRIPTION

FIG. 1. depicts an exemplary object 10 with a composite material having layers 12, 14, and 16 disposed on at least a portion of a base object 20. The composite material is depicted as being applied directly atop base object 20 and encompassing the entirety of base object 20 as its outer surface to form exemplary object 10. Other physical arrangements are contemplated. For example, more than two layers of conductive material could be used with insulative material between adjacent conductive layers. For another example, the composite material need not cover the entirety of the base object 20. The composite material can be on portions or in portions (not necessarily at the outermost surface) of the base object 20. For example, for handling, corrosion resistance or other purposes, it may be that some or all of the outermost surface of the base object 20 is insulative, and that the composite material is underneath relatively near the outer surface an exemplary object 10. The composite material any of a number of structures. The composite material can be formed as panels added to, attached to or adhered to a base object 20, or the composite material may be integrally formed with the base object 20.

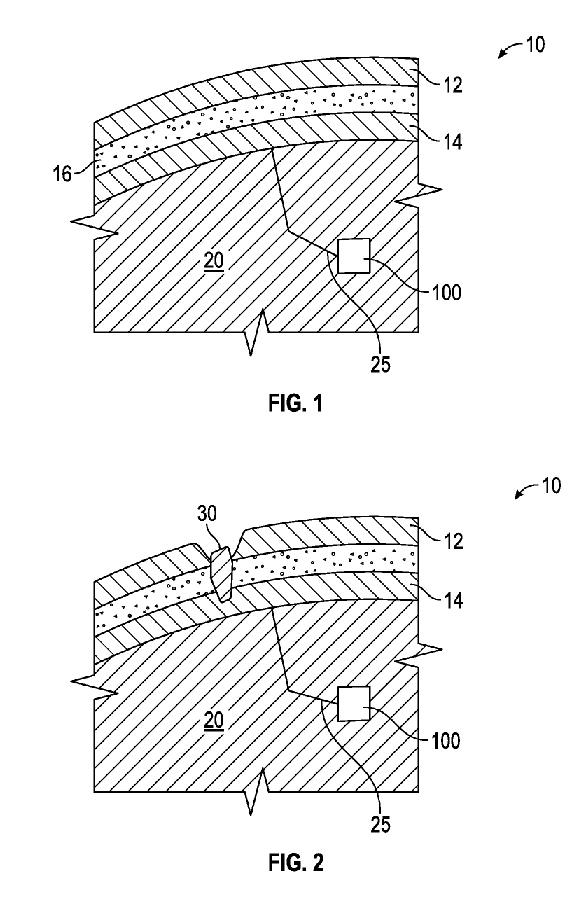

Layers 12 and 14 comprise conductive material, and layer 16 comprises insulative material. With reference to FIG. 2, when a bullet or other conductive projectile 30 pierces layer 12 and contacts layer 14, an electrical connection may be formed for a brief period until projectile 30 is no longer in contact with layer 12. The electrical connection may generate a signal communicated through connection 25 to an electronic control unit (ECU) or controller. Controller 100 may optionally include computer readable storage media for storing data representing instructions executable by a computer or microprocessor. Computer readable storage media may include one or more of random access memory as well as various non-volatile memory such as read-only memory or keep-alive memory. Computer readable storage media may communicate with a microprocessor and input/output circuitry via a standard control/address bus. As would be appreciated by one of ordinary skill in the art, computer readable storage media may include various types of physical devices for temporary and/or persistent storage of data. Exemplary physical devices include but are not limited to DRAM, PROMS, EPROMS, EEPROMS, and flash memory.

The signal may include data specific to the hit event. The data may include any of a number of facts, including the fact of being hit, time information, GPS location information, location of the hit on the object, impact information (e.g., velocity at impact, force of impact), and information identifying the specific covered object 10 that experienced at least one hit event. The hit event data may be stored and/or processed in computer readable form that can be accessed remotely through satellites or other methods. The hit event data may be displayed on a display device such as a computer monitor, a tablet, a phone, or other device capable of displaying data.

Conductive layer 12 may itself include one or more layers of conductive material. Any of a number of conductive materials are contemplated. By way of non-limiting example, coated or uncoated metals in pure or substantially pure form, metal alloys, semiconductive materials, conductive polymers and graphite may be suitable. Aluminum, copper, annealed copper, and/or oxygen-free high conductivity copper may be suitable for use in a conductive layer 12. In some embodiments, copper may be coated or plated with another material. Such other material may include, without limitation, silver or nickel. In some embodiments, conductive layer 12 may include tungsten, platinum, palladium, rhodium, iridium, osmium, or ruthenium. Conductive layer 12 may have a thickness of less than 2 inches, less than 1 inch, less than 0.5 inches, less than 0.25 inches, or less than 0.1 inches. It is contemplated that dimension figures may be less than or greater than those expressly disclosed.

Conductive layer 14 may comprise the same or different materials from conductive layer 12, and conductive layer 14 may have the same or different thickness dimensions from conductive layer 12. Additionally, like conductive layer 12, conductive layer 14 may actually comprise one or more layers to form a collective layer referred to as conductive layer 14.

Insulative layer 16 may comprise any of a number of materials. By way of non-limiting example, insulative layer 16 may comprise natural or synthetic rubber, polymeric material, or other insulators. The thickness of insulative material 16 should be less than the length dimension of ammunition or other projectiles sought to be detected. Insulative layer 16 may be less than 1 inch thick, less than 0.5 inches thick, less than 0.25 inches thick, or less than 0.1 inch thick. It is contemplated that dimension figures may be less than or greater than those expressly disclosed.

Connection 25 may be any of a number of known or future developed ways of communicating signals from one destination to another. Processor 100 can be an electric control unit in or on or in electrical communication with the object 10. Processor 100 may store or process data received from a signal generated when electrical contact is made between conductive layer 12 and conductive layer 14. Raw and or processed data may be stored and accessed remotely by any of a number of known or future-developed methods and systems. An exemplary hit detection system may include, for example, one or more objects, each including some composite material, a connection, a communication vehicle and hardware and software for storing and processing data generated by one or more hit events.

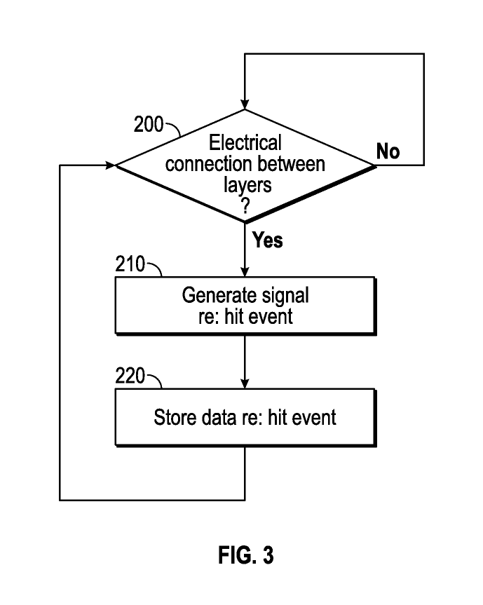

Referring to FIG. 3, an exemplary method is described of detecting and/or communicating a hit event on an object 10. In decision box 200, a system awaits detection of an electrical connection between conductive layers 12 and 14. When there is no connection, there is no hit event. The system continues to await detection of such a hit event. As referenced in box 210, upon detection of an electrical connection, a circuit is completed and a signal is generated that pertains to a detected hit event. The signal may be able to communicate a number of facts about the hit event, based upon input such as the length of the electrical connection. If multiple hits occur in multiple places on object 10 at overlapping time intervals, the length of an electrical connection may be longer, for example, thereby generating a signal having different data to communicate than a one-off hit event in a single location on object 10. The data may include any of a number of facts, including the fact of being hit, number of hits, time information, GPS location information, location of the hit on the object, impact information (e.g., velocity at impact, force of impact), and information identifying the specific covered object 10 that experienced at least one hit event.

As referenced in box 220, the hit event data may be stored and/or processed in computer readable form that can be accessed remotely through satellites or other methods. The data may be processed locally or remotely, and may be read from control stations tracking objects 10 and making decisions about the objects 10.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1. A composite material, comprising:
a first layer of conductive material;
a second layer of conductive material; and
at least one layer of insulative material between the first and second layers of conductive material, whereby when the composite material is pierced by a conductive projectile, the conductive projectile forms an electrical connection between the first layer and the second layer thereby generating a signal to indicate a hit event.

2. The composite material of claim 1 wherein the first and second layer conductive material comprise the same material.

3. The composite material of claim 1 wherein the first and second layer conductive material comprise the different material.

4. An unmanned vehicle comprising the composite material of claim 1.

5. A hit detection system comprising a plurality of the umanned vehicles of claim 4, a controller capable of receiving and processing signals sent containing data about a hit event, and a remote display device for displaying hit event data.

6. A composite material, comprising:
at least two layers of conductive material; and
at least one layer of insulative material between layers of conductive material, whereby when the composite material is pierced by a conductive projectile, the conductive projectile forms an electrical connection between adjacent conductive layers thereby generating a signal to indicate a hit event.

7. An object formed at least in part from the composite material of claim 6.

8. An object covered at least in part by one or more panels comprising the composite material of claim 6.

9. An umanned vehicle comprising one or more panels of claim 8.

10. A hit detection system comprising a plurality of the umanned vehicles of claim 9, a controller capable of receiving and processing signals sent containing data about a hit event, and a remote display device for displaying hit event data

11. A method of tracking hit events on unmanned objects, comprising:
equipping at least a portion of unmanned objects with a composite material comprising a first layer of conductive material; a second layer of conductive material; and at least one layer of insulative material between the first and second layers of conductive material;
generating a signal when a conductive projectile causes a hit event by piercing the insulative material to form an electrical connection between the first and second conductive layer, the signal carrying data about the hit event;
sending the signal with the hit event data to a controller; and
storing the data about the hit event in computer readable memory that can be accessed and displayed remotely.

12. The method of claim 11 wherein the unmanned objects are umanned vehicles.

13. The method of claim 11 further comprising remotely viewing the data about hit events on a display device.
